(19) United States
(12) Patent Application Publication
(10) Pub. No.: US 2014/0327728 A1
(43) Pub. Date: Nov. 6, 2014

(54) METHOD AND SYSTEM FOR MAPPING VIRTUAL CONFERENCE ROOMS BETWEEN 2 INDEPENDENT SYSTEMS

(71) Applicant: AVAYA, INC., Basking Ridge, NJ (US)

(72) Inventors: Ori Modai, Ramat Hasharon (IL); Ignacio Miranda, Madrid (ES); Moni Manor, Santa Clara, CA (US); Roy Shepard, McKinney, TX (US); Gregory Osterhout, Richardson, TX (US)

(73) Assignee: AVAYA, INC., Basking Ridge, NJ (US)

(21) Appl. No.: 13/874,649

(22) Filed: May 1, 2013

(51) Int. Cl. H04N 7/15

(52) U.S. Cl. CPC H04N 7/15
USPC 348/14.08

(57) ABSTRACT

Disclosed is a system and method integrating two different conferencing systems through an automatic mapping mechanism. Conference across two different systems are automatically connected without users in both systems being required to be provisioned.

### FIELD OF THE INVENTION

The field of the invention relates generally to mapping conference rooms between two independently provisioned systems.

### BACKGROUND OF THE INVENTION

As organizations and individuals interact over eve r-in-creasing distances, and communication technology advances and becomes less expensive, more and more people are using video conferencing systems.

A teleconference is the live exchange and mass articulation of information among several persons and machines remote from one another but linked by a telecommunications system. Terms such as audio conferencing, telephone conferencing and phone conferencing are also sometimes used to refer to teleconferencing. The telecommunications system may support the teleconference by providing one or more of the following: audio, video, and/or data services by one or more means, such as telephone, computer, telegraph, teletypewriter, radio, and television. Internet teleconferencing includes internet telephone conferencing, videoconferencing, web conferencing, and Augmented Reality conferencing.

Videoconferencing is the conduct of a videoconference by a set of telecommunication technologies which allow two or more locations to communicate by simultaneous two-way video and audio transmissions. The components within a Conferencing System can be divided up into several different layers: User Interface, Conference Control, Control or Signal Plane, and Media Plane. Videoconferencing User Interfaces (VUI) can be either be graphical or voice responsive. Normally graphical interfaces are encountered on a computer. User interfaces for conferencing have a number of different uses; they can be used for scheduling, setup, and making a video call. Through the user interface the administrator is able to control the other three layers of the system. Conference Control performs resource allocation, management and routing. This layer along with the User Interface creates meetings (scheduled or unscheduled) or adds and removes participants from a conference. Control (Signaling) Plane contains the stacks that signal different endpoints to create a call and/or a conference. Signals can be, but aren't limited to, H.323 and Session Initiation Protocol (SIP) Protocols. These signals control incoming and outgoing connections as well as session parameters. The Media Plane controls the audio and video mixing and streaming. This layer manages Real-Time Transport Protocols, User Datagram Packets (UDP) and Real-Time Transport Control Protocol (RTCP). The RTP and UDP normally carry information such the payload type which is the type of codec, frame rate, video size and many others. RTCP on the other hand acts as a quality control Protocol for detecting errors during streaming.

Simultaneous videoconferencing among three or more remote points is possible by means of a Multipoint Control Unit (MCU). This is a bridge that interconnects calls from several sources (in a similar way to the audio conference call). All parties call the MCU, or the MCU can also call the parties which are going to participate, in sequence. There are MCU bridges for IP and ISDN-based videoconferencing. There are MCUs which are pure software, and others which are a combination of hardware and software. An MCU is characterized according to the number of simultaneous calls it can handle, its ability to conduct transposing of data rates and protocols, and features such as Continuous Presence, in which multiple parties can be seen on-screen at once. MCUs can be stand-alone hardware devices, or they can be embedded into dedicated videoconferencing units.

The MCU consists of two logical components: A single multipoint controller (MC), and Multipoint Processors (MP), sometimes referred to as the mixer. The MC controls the conferencing while it is active on the signaling plane, which is simply where the system manages conferencing creation, endpoint signaling and in-conferencing controls. This component negotiates parameters with every endpoint in the network and controls conferencing resources While the MC controls resources and signaling negotiations, the MP operates on the media plane and receives media from each endpoint. The MP generates output streams from each endpoint and redirects the information to other endpoints in the conference.

### SUMMARY OF THE INVENTION

An embodiment of the invention may therefore comprise a method of connecting at least two conferencing systems, the method comprising provisioning a first of the at least two conferencing systems and enabling a second of said at least two conferencing systems to create a link with the first of the at least two conferencing systems, wherein the second of the at least two conferencing systems is not provisioned.

An embodiment of the invention may further comprise a system for connecting two independent conferencing systems, the system comprising a provisioned system, wherein the provisioned system is enabled to create a conference requiring access credentials and a mapped bridge system comprising an algorithm, wherein the algorithm is enabled to define a range of numbers and create a conference in the mapped bridge system requiring a conference code within a predefined set of parameters and the mapped bridge system is enabled to automatically link to a conference in the provisioned system using the predefined set of parameters.

### BRIEF DESCRIPTION OF THE DRAWINGS

FIG. 1 shows a conference system with a mapped and provisioned system.

FIG. 2 shows the call routing for a mapped conference system and a provisioned conference system.

### DETAILED DESCRIPTION OF THE EMBODIMENTS

A user will generally arrive at a mapped conferencing system and enter a conference code. The code may be within a range of defined numbers. If so, the conferencing system can create a link with a provisioned system and use the same credentials within the map range that were entered by the user.

In an embodiment of the invention, in a mapped conferencing system an automatic mechanism is used to map conferences across two different systems. The interconnection between the systems may be automatically facilitated.

The application software in one of the systems used in the conferencing defines a range of numbers and creates a conference for users that dial in to the conference. The users will dial in with credentials within the number range defined by the application software. For reference purposes, this system with the application software that defines a range of numbers may be referred to as a bridge system. A second system may be provisioned with regular users who have credentials for the second system. For reference purposes, this second system may be referred to as a provisioned system. The credential may be conference access codes for the second system or similar credentials. The credentials of the regular users may be constrained to the range of numbers defined in the bridge system. Accordingly, the constrained range of numbers in the provisioned system will be within the map range. Providing that both systems will have a same range of numbers, or credentials, a system administrator will not be required to provision both systems.

A user will arrive at a mapped conferencing system by dialing a phone number. It is understood that there are many known ways to connect to a conferencing system. A user will enter a conference code to connect with a particular conference. The conference code will be within the range of numbers defined in the bridge system. The conferencing system will create a link with the provisioned system and utilize the same credentials within the map range as those entered by the user. The credentials may match a conference in the mapped conference system and the two systems are interconnected. The interconnection is limited for the conference to which the user entered the credentials. Callers which arrive at either the bridge system or the provisioned system are linked through the mapped conference system to enable communication between all users connecting to the same conference.

The mapped conferencing system application software will automatically use whatever credentials were entered by the user to make a call into the same conference as that of the provisioned system. The call may be made using SIP or other means. The call is directed to the correct conference room by embedding the conference information in the call. For instance, the conference room information may be embedded in the SIP headers. U.S. Pat. No. 7,881,297 to Braudes et al. provides one mechanism of providing communications using headers. This patent is specifically incorporated herein, by reference, for all that it discloses and teaches.

There may be a second level security requirement for a particular conference. This second level security requirement may be a passcode or other mechanism. A participant may be required to enter the second level security requirement to gain access to the conference. The application software may also be enabled to embed the second level security requirement information in the SIP header, for example, when the call is made to the provisioned system. In this manner, the single call made from the bridge system to the provisioned system which will link he two systems will also authenticate all of the information correctly.

It is understood that the mapped system does not have to be provisioned with any of the conferences. It may also not have references to the conference codes in the provisioned system. All that is required is that software application be enabled and to allow mapping between access codes ranges in a MCU bridge. Those access codes are understood to coincide with the provisioned system's participant codes. The participant code forwarded may be the entire set of numbers entered or a predictable subset. For example, the provisioned system may be configured with 6 digit passcodes and the range of numbers in the mapped system would be the rightmost 6 digits. It is understood that these options are configurable.

The mapped system may automatically trigger a dial out to the provisioned system to cascade the conference. In a typical situation, this may be performed by the mapped system as soon as a user dials into the mapped bridge with an access code within the defined range set. As noted above, in one example, the access code may be included in the SIP INVITE to allow joining with the conference in the provisioned system.

In an embodiment of the invention, a provisioned system may require a type of random numbers and thereby be unable to define a range for the provisioned users. In such a situation, the mapped system may introduce a prefix to identify the range. Accordingly, the numbers within the prefix would be mapped to the users in the provisioned system. For example, a defined range may be from 880000 to 889999 in the mapped system to be linked to the provisioned system. A caller may arrive at the conference with credentials of 881234. The mapped system will automatically create a link, either with an SIP call as used in examples or otherwise, to the provisioned system. The conference access code ‘1234’ will be introduced automatically to the provisioned system. This will map to a conference in the provisioned system. Other callers accessing the provisioned system with the same credentials, ‘1234’, will be able to communicate with other callers in the mapped system.

In the event that the conference also has a PIN requirement, as discussed above in regard to a second level requirement, the same mechanism may be utilized to provide the additional credentials when creating the link between the two systems. In the event that the same secondary requirement is provisioned, then the link will be successful. As discussed, the mechanism may be an SIP (standard interchange protocol), URI (uniform resource identifier), DTMF (dual-tone multi-frequency signaling) or other mechanism allowing for exchange of information between systems.

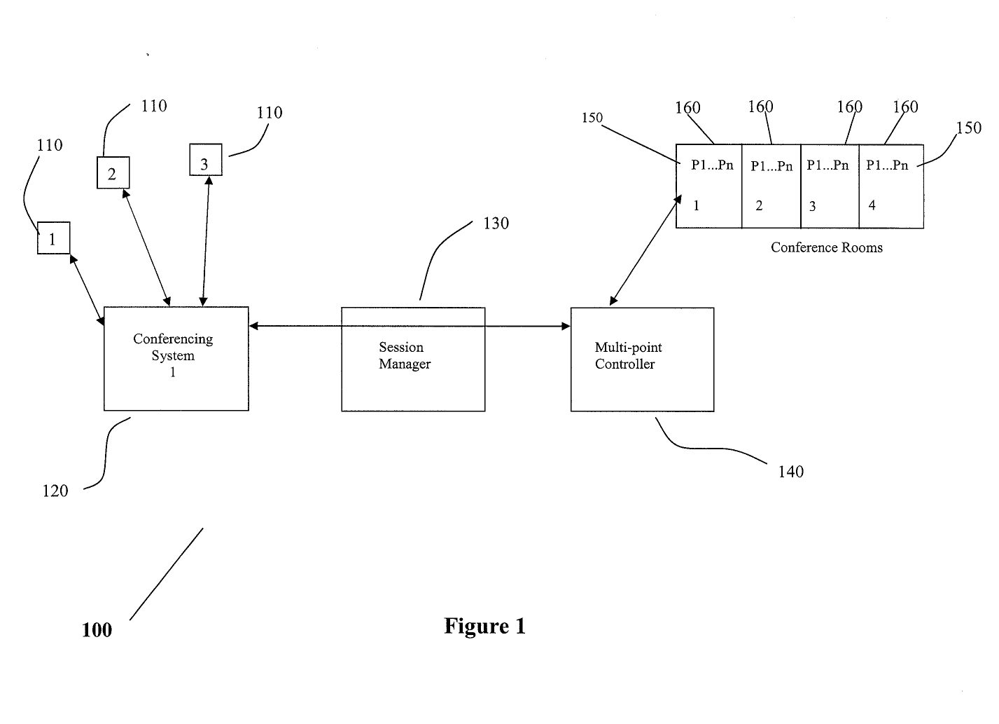

FIG. 1 shows a conference system with a mapped and provisioned system. The overall system 100 comprises a number of bridge conference attendees 110, a first conferencing system 120, a session manager 130, a multi-point controller (MCU) 140 and a number of conference rooms 160 in a conference room system 150. The conference attendees 110 may be any type of communication device capable of communicating in a conference, including, but not limited to, audio, visual and combination devices. The conferencing system 120 may be any type of device capable of acting as a mapped or bridge system, including, but not limited to, audio, visual or combination coding devices. The session manager 130 may be any type of session manager capable of processing communications between the first conferencing system 120 and the MCU 140. The MCU 140 may be any type of controller capable of providing computer networking and telecommunications, including unified communication video or audio conferencing with two or more video or audio endpoint options. The conferee rooms 160 may be any type of communication devices capable of communicating in a conference, including, but not limited to, audio, visual and combination devices.

In operation a user at a conference attendee 110 location enters a dial URI, for example, and the participant or moderator code. This code will be within a range previously defined. A link will be created via the session manager 130 between the conferencing system 120 and the multipoint controller 140. A conference is interconnected so that participants (denoted P1 . . . Pn) 150 in a conference room 160 can interact with the conference attendees 110 provided that the credential information provided by the attendee matched properly. While the conference room 150 may have been provisioned by an administrator, no such provisioning is required for the bridge system, or conferencing system 120.

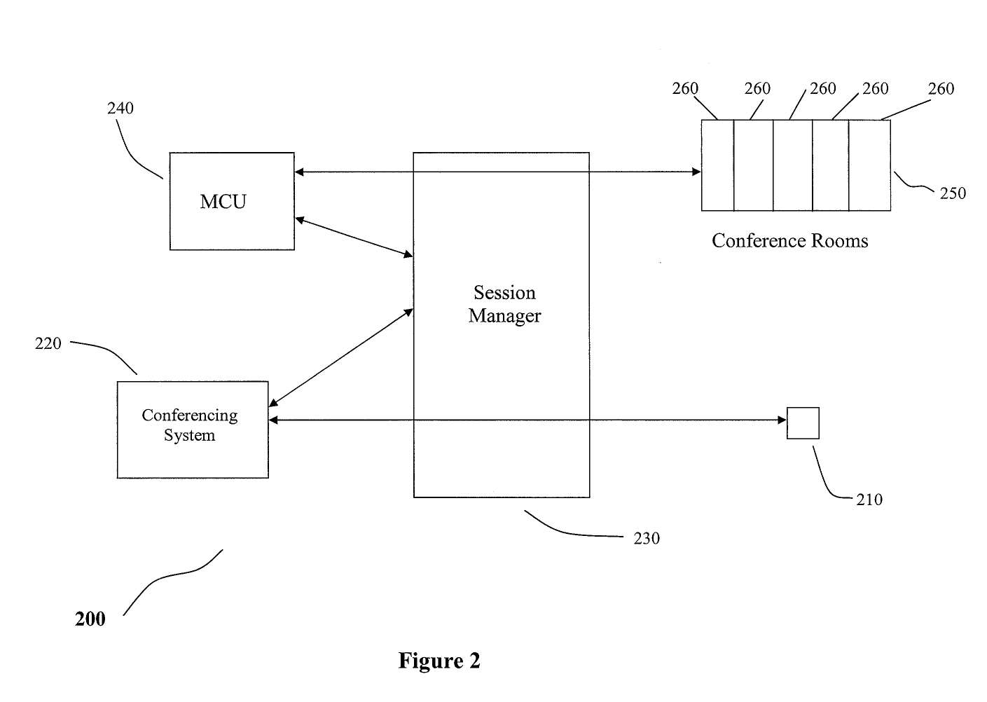

FIG. 2 shows the call routing for a mapped conference system and a provisioned conference system. The overall system comprises at least one bridge conference attendee 110, a first conferencing system 120, a session manager 130, a multi-point controller 140 and a number of conference rooms 160 in a conference room system 150.

Calls to the conferencing system 120 will use a number designated for the conference system. This may be a typical 9-digit phone number. This call is configured to be routed to the conferencing system 120 using an SIP address format, for instance SIP:+12346578900@name.com. An access code may be entered. One or more users may dial a particular number for conferencing system 120 and enter a particular access code. The participants are mixed locally together at the conference system 120. The participants, while mixed together locally, then linked to conferences 150 in a conference room 160. A link from the conferencing system 120 to the session manager 130 is routed based on the telephone number and the access code, for instance SIP:+12345678900@name.com;accessCode=885678. For this example, an access code of 885678 is assumed. Calls that originate from conference rooms 160 will dial into a MCU 140 using an address such as SIP:885678@name.com. It is understood by those skilled in the art that the linkage of conference systems and rooms may occur when differing services or differing users/clients are attempting to interface.

In an embodiment of the invention, the session manager and the MCU may be located in the same local area network. In this manner, bandwidth may be used efficiently. For instance, a media server may be part of a cascaded conference and not the host of the conference. Such an arrangement may introduce delay between the users in the MCU and the other cascaded media servers.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of connecting at least two conferencing systems, said method comprising:
provisioning a first of said at least two conferencing systems; and
enabling a second of said at least two conferencing systems to create a link with the first of said at least two conferencing systems,
wherein said second of said at least two conferencing systems is not provisioned.

2. The method of claim 1, wherein said process of enabling comprises defining a range of numbers and creating a conference for users to dial into.

3. The method of claim 2, wherein said process of provisioning comprises identifying a first set of credentials constrained to said range of numbers.

4. The method claim 1, said method further comprising:
receiving a user request to join a conference at said second of said at least two conferencing systems, said request comprising access information.

5. The method of claim 4, wherein said access information comprises a conference code.

6. The method of claim 4, wherein:
said process of enabling comprises defining a range of numbers and creating a conference for users to dial into; and
said process of provisioning comprises identifying a first set of credentials constrained to said range of numbers.

7. The method of claim 1, wherein said process of enabling comprises embedding at least one credential into a protocol and automatically linking to said first of said at least two conferencing systems.

8. The method of claim 7, wherein said at least one credential comprises a code that is within a range of predefined numbers for accessing a conference in said first of said at least two conferencing systems.

9. The method of claim 7, wherein said at least one credential comprises a code that is within a range of predefined numbers for accessing a conference in said first of said at least two conferencing systems and a second level passcode.

10. The method of claim 1, wherein said process of enabling comprises implementing an algorithm wherein said algorithm enables mapping between access code ranges of said second of said at least two conferencing systems and participant codes of said first of said at least two conferencing systems.

11. A system for connecting two independent conferencing systems, said system comprising:
a provisioned system, wherein said provisioned system is enabled to create a conference requiring access credentials; and
a mapped bridge system comprising an algorithm,
wherein said algorithm is enabled to define a range of numbers and create a conference in said mapped bridge system requiring a conference code within a predefined set of parameters and said mapped bridge system is enabled to automatically link to a conference in said provisioned system using said predefined set of parameters.

12. The system of claim 11, wherein said code within a predefined set of parameters is embedded in a protocol header and said code matches the access credentials of said provisioned system.

13. The system of claim 11, wherein said access credentials are constrained to be within said predefined set of parameters.

14. The system of claim 13, wherein said code within a predefined set of parameters is embedded in a protocol header.

15. The system of claim 14, wherein said protocol header is an SIP protocol header.

16. The system of claim 11, further comprising a session manager wherein said session manager facilitates the link between said mapped bridge system and said provisioned system.

17. The system of claim 16, wherein said access credentials are constrained to be within said predefined set of parameters.

18. The system of claim 17, wherein said code within a predefined set of parameters is embedded in a protocol header.

19. The system of claim 18, wherein said protocol header is an SIP protocol header.
